(19) United States
(12) Patent Application Publication
(10) Pub. No.: US 2015/0025984 A1
(43) Pub. Date: Jan. 22, 2015

(54) Method for making orders without wired or wireless connection and without in person contact

(71) Applicant: Dimple A. KATIRA, Raleigh, NC (US)

(72) Inventor: Dimple A. KATIRA, Raleigh, NC (US)

(21) Appl. No.: 14/502,822

(22) Filed: Sep. 30, 2014

Related U.S. Application Data
(63) Continuation-in-part of application No. 13/369,631, filed on Feb. 9, 2012.

(51) Int. Cl. G06Q 30/06; G06K 19/06

(52) U.S. Cl. CPC G06Q 30/0633; G06K 19/06037
USPC 705/15

(57) ABSTRACT

An application for coding and decoding an order of product or service can be installed in a handheld device, such as a mobile phone or a tablet device, to help make an order with no need of talking with a clerk at the store. This application, after receiving the order, is able to convert the received order into a code, wherein the code may be a conventional bar code or a matrix bar code which is capable of storing more information. At a location of a vendor, the user of the application is able to direct scan the generated code with a reading device at the location, such as a scanner. The scanner is able to read the code and then convert it back to the order information which will be further automatically sent to the vendor to make the order.

The current application is a Continuation-In-part application of the U.S. Non-provisional patent application Ser. No. 13/369,631, filed on Feb. 9, 2012.

### FIELD OF THE INVENTION

The present invention relates generally to a method for making orders. More specifically, it is a method of making orders with a store or other vendors with no need of any form of connection, including wired connection and wireless connection, and meanwhile, no need for in person contact with store personnel.

### BACKGROUND OF THE INVENTION

Making an order is one of the most common activities that people are doing every day. It could be an order of a product, a food or a service. When making an order at a restaurant, especially at a fast food restaurant, a customer usually needs to communicate with a store clerk, no matter it is a drive-through order or a dine in order, the customer needs to talk to the clerk to tell the order, and then the clerk usually would repeat it and request for confirmation, and so on. The foregoing seems to be natural and free of problem. However, in a real world scenario, a single clerk generally needs to take care of many clients, and many times, there is a line of people waiting in front of the clerk.

In the scenario mentioned above, if a person in the line has some difficulty communicating with the store clerk efficiently, the waiting line would get longer. In such a case, it may damage the store's business, but also waste many customers time. For example, a person who is not a native English speaker was ahead of me in drive-through at a popular fast food restaurant. The line was not moving because despite the best attempts of this customer to verbally convey the order, the store clerk at the drive through was unable to accurately capture this order. Finally after several attempts the restaurant got the order right but it took a while, and the line became even longer.

The foregoing case is not rare. In particular, there are increasingly more people whose native language is not English are living in the U.S. As a result, it would be a challenge of the oral communication between them and a native English speaker, or between persons whose native languages are not English and not the same language.

In light of the foregoing, many customers may prefer to make their orders via another way rather than talking with a store clerk in person. Therefore, if a fast food restaurant is able to provide such service, they would prefer to go to this restaurant.

On the other hand, with the fast progress of IT and mobile technologies, now people indeed can make an order with a computer through a restaurant's website or with a mobile device (mobile phone, tablet device and the like) through an application. However, it is noted that no matter it is an order via a website or an order via a mobile app, a certain type of connection is always necessary, such as internet connection via cable, DSL, fiber optic, Wi-Fi and so on, and mobile connection via cellular network (2G, 3G, 4G) and so on. In this concern, if there is no such connection available or for some reason, a customer does not want to use his or her data plan, then such online order through certain signal connection would become impossible.

Therefore, there would be a need for an approach for making orders, which does not need to talk with a store clerk in person and does not need any type of connection, wired, wireless or cellular. On the other hand, traditionally encoding of goods for retail sales has been the responsibility of businesses. Retail outlets, shipping companies, manufacturers all use some form of encoding, such like bar codes, QR codes etc. to identify specific items. With the rapid penetration of smart handheld devices like smart phones the individual customers carry in their pocket/purse a very powerful device with a computing power very much capable of reversing this tradition of encoding items. This reversal of responsibility has a huge potential in terms of efficiency, accuracy and certainly cost savings for both the customer and the business.

The current order process has a vast room for improvement. An example of such a business is the Fast Food industry. It is believed that using a particular industry just as an example helps us articulate the concept better. This does not mean that the application & scope of this concept is just limited to this industry only. The current process requires a customer to stand in line at the counter or drive-thru, convey their order verbally which is error prone, time consuming and frustrating process for the customer thereby compounding the delay for the subsequent customers. This concept eradicates the unpleasant and unintelligible aspects from the current ordering process.

Many businesses have a very structured product item categorization. The clear categorization, presentation and in this case even numbering of product items makes such businesses an ideal use case for taking advantage of this concept and the associated technology offering. For a structured business like the Fast food industry, the order can simply be defined as an enumeration of one of the unique permutation of items offered along with the quantity of each item and possible customer customizations. In this case, the Fast Food vendor would offer a software component that would enable the customer to capture their orders without being physically present at the order fulfillment location using smart handheld device based technology (Android or iPhone device for example).

A QR code (abbreviated from Quick Response Code) is a type of matrix barcode (or two-dimensional barcode), which is a machine readable optical label that contains information. A QR code uses four standardized encoding modes (numeric, alphanumeric, byte/binary, and kanji) to efficiently store data. The QR code system has become popular outside due to its fast readability and greater storage capacity compared to the standard UPC barcodes. Applications include product tracking, item identification, time tracking, document management, general marketing, and much more.

A QR code consists of black modules (square dots) arranged in a square grid on a white background, which can be read by an imaging device (such as a camera) and processed using Reed-Solomon error correction until the image can be appropriately interpreted. The required data are then extracted from patterns present in both horizontal and vertical components of the image. Originally designed for industrial uses, QR codes have become common in consumer advertising. Typically, a smart phone or other mobile device such as a tablet is used as a QR-code scanner, displaying the code and converting it to some useful form (such as a standard URL for a website, thereby obviating the need for a user to type it manually into a web browser). In the shopping industry, knowing what causes the consumers to be motivated when approaching products by the use of QR codes, advertisers and marketers can use the behavior of scanning to get consumers to buy, causing it to have the best impact on ad and marketing design.

Therefore, one objective of the present invention is to provide a simple and convenient process for people to make orders with a store or restaurant, which does not need an in person communication with a store clerk. In addition, it is also different from the online order via a website or a mobile app, which always needs some types of signal connection. The present invention can be easily implemented by an individual user by virtue of his or her mobile device. However, it is noted that no any connection for such mobile device is necessary. Therefore, the present invention can be used in almost anywhere, even at the location where there is no internet connection and/or no cellular signal. Furthermore, the present invention employs the QR code system to store the entire order information, which can be easily generated, stored, scanned and presented.

### BRIEF DESCRIPTION OF THE DRAWINGS

FIG. 1 depicts the process of making an order with the application of the present invention.

FIG. 2 depicts the process of coding and decoding the matrix bar code.

FIG. 3 depicts the process of using the application to make an order by a user.

FIG. 4 depicts the process of placing the order at a vendor's location.

FIG. 5 shows an example of the generated matrix bar code.

### DETAIL DESCRIPTIONS OF THE INVENTION

All illustrations of the drawings are for the purpose of describing selected versions of the present invention and are not intended to limit the scope of the present invention.

In the present invention, a customer can place an order either at their home, office or even en route to the fast food location without any human to human conversation using a software component on their smart handheld device with no connectivity prerequisites in a self-serve model. As the customer places the order, the application guides them through the menus and shows them at each point what they are ordering. This application accommodates any order customization as well. The application provides interactive feedback at each point and finally confirming the order with the customer. Once the order is confirmed, the software component will use an encoding algorithm to generate a code (bar code, QR code or any other industry standard or proprietary encoding) that represents their order. This encoding would then become the sole method by which order gets placed by the customer to the business with no verbal intervention or human to human interaction eliminating pitfalls associated with verbal communication like accents thereby guaranteeing a pleasant overall experience.

The key advantage is that the customer is not waiting in a line at the “drive-through” or inside the fast food outlet to verbally convey their order which accelerates the order captures process.

The decoding algorithm & tools deployed at the business side would then be responsible for reconstructing the order and subsequently fulfilling it. In this unique order lifecycle model, the order is generated in a distributed fashion, encoded remotely using technology on a customer device, decoded at the business site and fulfilled. The application for the patent covers the concept, the methods, technology and toolset needed that will enable businesses and customers to take advantage of this concept.

The present invention provides an application that can be installed and run on a mobile device such as a smart phone, or on any handheld device. The application functions to facilitate a customer who is using the application to make a quick order via the application, with no need to contact (by phone or internet) the vendor. Then the order will be saved by the application and then converted into a code, which could be in any suitable form, such as bar code, matrix bar code or QR code, and the like. The QR code is one preferred form as it is able to store more information. Next, the application user is able to bring the generated code to a vendor at any time. It is noted that when the code is generated, the user can use it to place the order at the vendor's location at any time, and the code can be used for unlimited times.

Later on, at the location of the vendor, the user can make an order by using the code with no need of talking or communicating with a clerk of the store. The user just needs to bring the QR code to a code scanner (at the vendor's location), which is able to read the QR code and output the stored order information. The order information will then be directly sent to the vendor to prepare the order. The next stage will be the user receives his or her order.

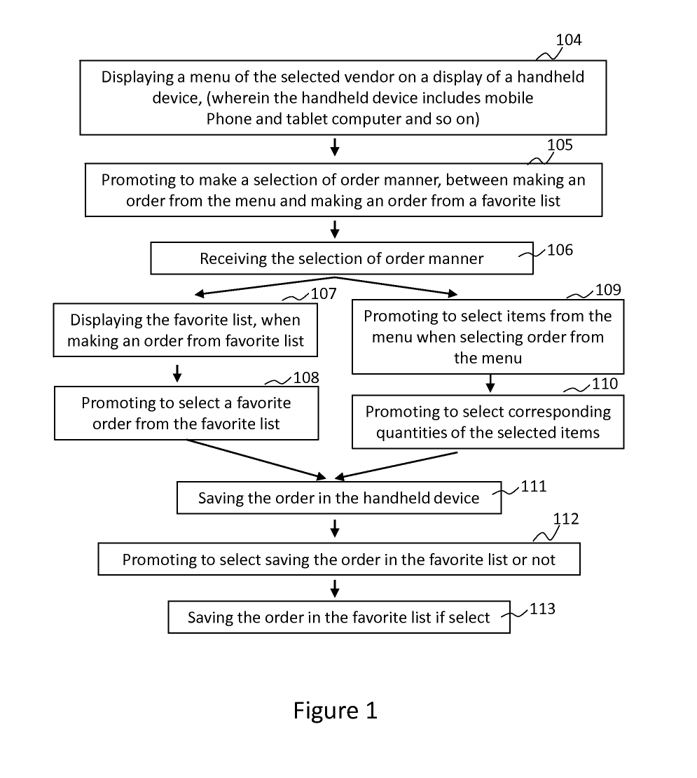

In reference to FIG. 1, the application mentioned above will display the menu of a vendor on the display of the handheld device that has been installed the present application 104. As mentioned before, the handheld used in the present invention is not limited to the mobile phone. It could be in any suitable form of a handheld device, such as a tablet computer, a touch screen computer and so on. At the same time, the user will be prompted to make a selection of order manner 105. It is noted that there are at least two forms of order manners. One is to make an order from the menu and select the wanted items one by one. The other one is to select a previously saved order from a favorite list stored by the application on the handheld device. In the second way, the user only needs to make one single selection, then the entire order, such as the list of ordered items, the corresponding quantity of each ordered item, and other associated factors (ketchup, salt, sugar and so on) are already included in the saved order. So, it is pretty convenient for a user who already has a favorite order. It is noted that the selection of items and their quantities from the menus can be made by either typing from a keyboard or speaking (voice) directly to the device.

Subsequently, after receiving the user's selection of the order manner 106, the application may then do one of the following two. In a case that an order manner of order from the menu has been selected, the application will promote the user to make a selection of the items from the menu 109. After each item has been selected, the user will be asked to select the quantity of this item 110. The foregoing step will be performed for each item in the menu the user wants. In this way, the user will complete an order from the menu. In another case, if the user believes he or she actually prefers a saved old order, then the user selects the order manner of making order from an old order saved in a favorite list. After receiving the foregoing selection, the application will display the favorite list 107, and at the same time, prompt the user to select 108 an old order saved in the favorite list.

No matter which manner has been used to make the order, after the order is completed, the application will save the order in the handheld device first 111. Next, the user will be asked whether want to save the just made order into the favorite list 112. If the user decides to do so, this order will be saved in the favorite list 113.

Moreover, the present invention is also able to customize the orders in order to meet the specific needs of individual customers, which includes but is not limited to the scenarios set forth below:

A customer who likes to customize orders or is sensitive to certain ingredients may customize his or her order by virtue of the present invention. The customization would be indicated in the readable code making sure the customer can enjoy their favorite customized product consistently at different retail locations by utilizing the same scan-able artifact stored as a favorite on their smart device. For example, the customization may include ordering an item from the menu such as coffee and customizing this coffee to include “2 cream and 3 bags of sugar”. In this way, a customer who likes a sweet drink may order a coffer along with a few bags of sugar; while the other customer may order his or her coffer without any sugar. All of the foregoing would be achieved by the present invention. Another example would be ordering a sandwich from the menu and customizing to include “no onions, double cheese”. In this example, different customers may have different preferences for cheese, onion and the like. In the present invention, they could be customized according to individual customer's preference.

The present invention is also able to make orders for different customers together (via a single code) and indicate that each customer's order shall be placed in an individual package. For example, a mom places an order for 4 kids. When one person places a family order involving multiple items, it is possible that the scan-able code would convey enough information to package the order by person in separate bags with names printed on bags.

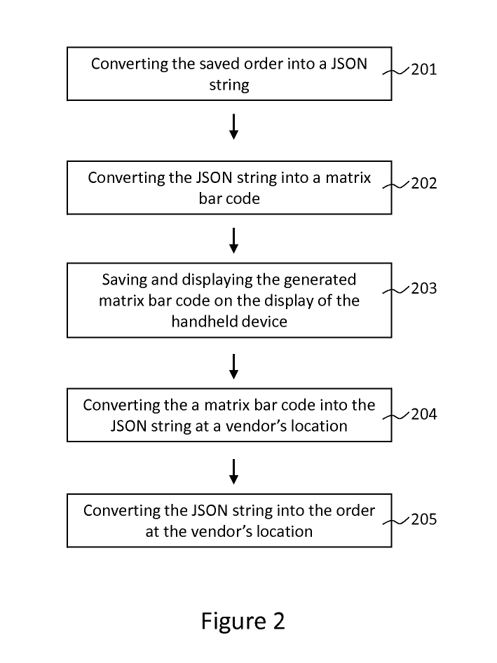

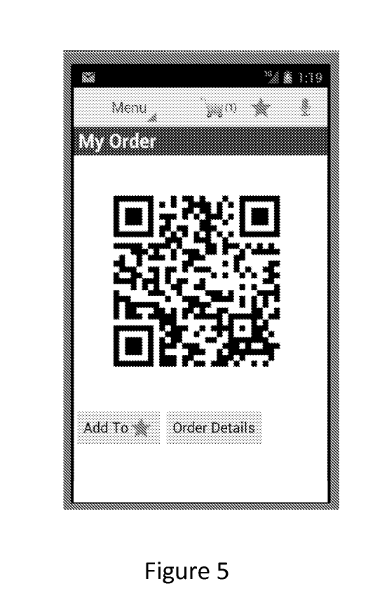

Further, in reference to FIG. 2, after the order made by the user being saved, the application will next convert the saved order into a JSON string 201, which is an order serialization process. This JSON string is then further converted by the encoding process in a matrix bar code such as QR code using a Zxing library 202. One example of the matrix bar code generated on a handheld device has been shown in FIG. 5. The generated matrix bar code is next shown on the display of the handheld device 203. Later on, at the vendor's location, the present invention is able to convert the matrix bar code back to the JSON string 204, and then the JSON string will be further converted back to the order information 205.

In addition to the above described application, the present invention also provides a method for making an order without needs of phone or internet connection, and without communication with a store clerk. By virtue of the application described above, a user can use this method to make an order, which is convenient and time saving.

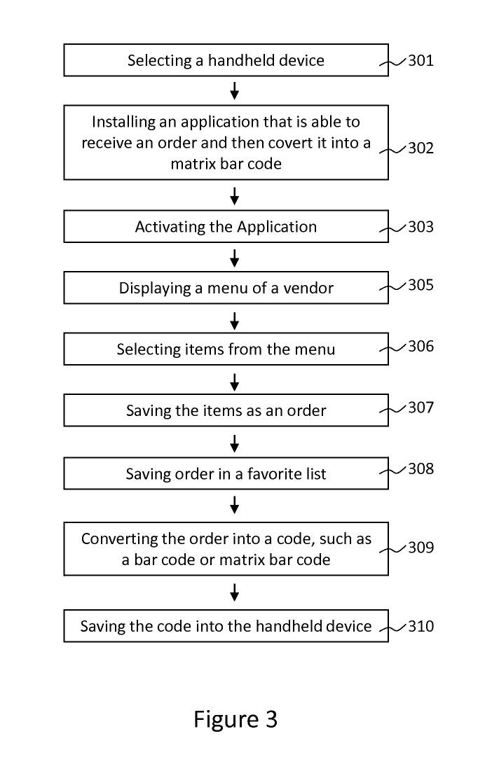

In reference to FIG. 3, a person first needs to select a handheld device 301 in order to make an order following the method provided in the present invention. The next step would be installing the application described above to this handheld device 302. As described previously, this application is able to coding and decoding an order made from an application user, and then covert the order into a code, such as a matrix bar code. The installed application will be next activated 303. The next a few steps would be making an order through the handheld device, which would be further converted to a code by the application installed in the handheld device. The procedures would be displaying a menu of a vendor 305, selecting items from the menu 306. And similarly, the order would be saved in the handheld device by the application 307, and then saved in a favorite list 308 if the user wants to do it.

Next, the application will convert the order information into a matrix bar code 309 as mentioned before, and the code would be further saved in this handheld device 310.

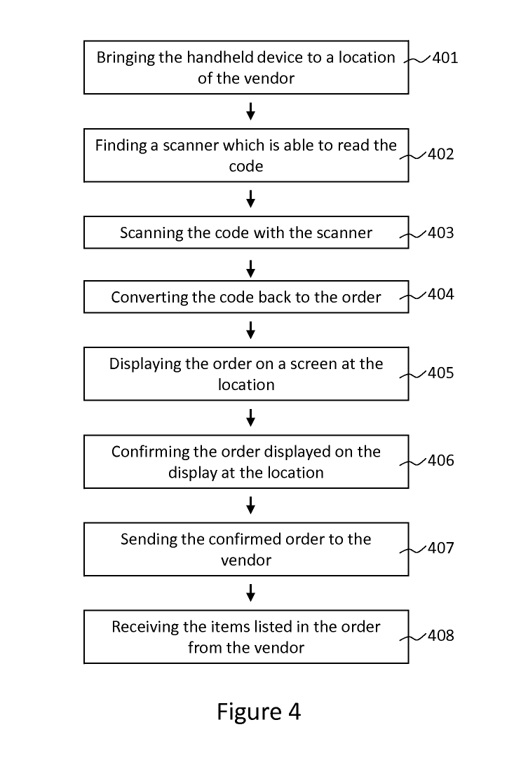

In reference to FIG. 4, after the code has been generated and stored on the handheld device, the user can go to a location of the vendor at any time. In a case when the user has decided to make the order at the location of the vendor, he or she just needs to bring the handheld device to a location of the vendor 401. At the location, the user needs to find a scanner provided in the store which is able to read the generated code 402. Next the user just needs to scan the code displayed on the handheld device 403. The scanner is able to covert the code back to the order information 404. In general, the order information may be shown on the screen for the user's final confirmation 405. After making the confirmation 406, the user just needs to wait for the order to be fulfilled by the vendor. Next, the user will receive the order 408 without communicating with store clerk, without waiting in the drive through line.

Although the invention has been explained in relation to its preferred embodiment, it is to be understood that many other possible modifications and variations can be made without departing from the spirit and scope of the invention as herein described.

What is claimed is:

1. A non-transitory computer-readable medium that stores instructions executable by one or more processors to perform an application for coding and decoding an order of product or service, comprising
instructions for displaying a menu of a vendor on a display of a handheld device; and
instructions for promoting to select an order manner, and the order manner being making order from items shown in the menu, or making order from old orders saved in a favorite list.

2. The non-transitory computer-readable medium that stores instructions executable by one or more processors to perform an application for coding and decoding an order of product or service as claimed in claim 1, comprising
instructions for receiving a selected order manner;
instructions for making an order;
instructions for saving the order in the handheld device;
instructions for promoting to save the order in the favorite list; and
instructions for saving the order in the favorite list.

3. The non-transitory computer-readable medium that stores instructions executable by one or more processors to perform an application for coding and decoding an order of product or service as claimed in claim 2, the instructions for making an order comprising
instructions for displaying the favorite list, when the order manner of making order from old orders saved in the favorite list is selected;
instructions for promoting to select an old order from the favorite list; and
instructions for ordering the old order selected.

4. The non-transitory computer-readable medium that stores instructions executable by one or more processors to perform an application for coding and decoding an order of product or service as claimed in claim 2, the instructions for making an order comprising
instructions for promoting to select items shown in the menu, when the order manner of making order from items shown in the menu is selected;
instructions for promoting to select quantities corresponding to items selected; wherein item selection and quantity selection are made via manual inputting with keys, via touching on a touch screen, or via voice; and
instructions for repeating the item selections and quantity selections for additional users.

5. The non-transitory computer-readable medium that stores instructions executable by one or more processors to perform an application for coding and decoding an order of product or service as claimed in claim 2, comprising
instructions for converting the order saved in the handheld device into a JSON string;
instructions for converting the JSON string into a matrix bar code;
instructions for saving the JSON string;
instructions for converting the matrix bar code to the JSON string at a vendor location; and
instructions for converting the JSON string to the order at the vendor location.

6. The non-transitory computer-readable medium that stores instructions executable by one or more processors to perform an application for coding and decoding an order of product or service as claimed in claim 4, comprising
the handheld device is a mobile phone;
instructions for customizing the order; and
instructions for ordering a sandwich and customizing to including various quantities of onion and cheese.

7. The non-transitory computer-readable medium that stores instructions executable by one or more processors to perform an application for coding and decoding an order of product or service as claimed in claim 5, comprising
the handheld device is a tablet computer; and
instructions for making the matrix bar code including a plurality of different orders corresponding to a plurality of individual customers; and
instructions for individually packing the plurality of different orders for the plurality of individual customers.

8. The non-transitory computer-readable medium that stores instructions executable by one or more processors to perform an application for coding and decoding an order of product or service as claimed in claim 1, comprising
the vendor is a fast food store.

9. A method for making an order of product or service with no need of communication with a store clerk, comprising the steps set forth below:
using a handheld device;
installing an application into the handheld device;
activating the installed application;
selecting items from a menu shown on the display of the handheld device;
repeating the item selection for additional users;
saving an order comprising the item selection;
converting the order into a code; and
saving the order as a JSON string into the handheld device.

10. The method for making an order of product or service with no need of communication with a store clerk as claimed in claim 9, further comprising the steps set forth below:
bringing the handheld device with the code to a location of a vendor;
finding a scanner provided by the vendor; wherein the scanner has a function of read the code;
scanning the code with the scanner;
converting the code back to the order;
displaying the order on a screen;
confirming the order shown on the screen; and
receiving items included in the order.

11. The method for making an order of product or service with no need of communication with a store clerk as claimed in claim 9, comprising:
the handheld device is a mobile phone.

12. The method for making an order of product or service with no need of communication with a store clerk as claimed in claim 9, comprising:
the handheld device is a tablet computer.

13. The method for making an order of product or service with no need of communication with a store clerk as claimed in claim 9, comprising:
the application is an application for making an order of product or service and converting the order into a code.

14. The method for making an order of product or service with no need of communication with a store clerk as claimed in claim 9, comprising:
the code is a bar code.

15. The method for making an order of product or service with no need of communication with a store clerk as claimed in claim 9, comprising:
the code is a matrix bar code.

16. The method for making an order of product or service with no need of communication with a store clerk as claimed in claim 10, comprising:
the vendor is a fast food store.

17. A non-transitory computer-readable medium that stores instructions executable by one or more processors to perform an application for coding and decoding an order of product or service, comprising
instructions for displaying a menu of a vendor on a display of a handheld device;
instructions for promoting to select an order manner, and the order manner being making order from items shown in the menu, or making order from old orders saved in a favorite list;
instructions for receiving a selected order manner;
instructions for making an order;
instructions for saving the order in the handheld device;
instructions for promoting to save the order in the favorite list;
instructions for saving the order in the favorite list;
instructions for converting the order saved in the handheld device into a JSON string;
instructions for converting the JSON string into a matrix bar code;
instructions for saving the JSON string;
instructions for converting the matrix bar code to the JSON string at a vendor location; and
instructions for converting the JSON string to the order at the vendor location.

18. The non-transitory computer-readable medium that stores instructions executable by one or more processors to perform an application for coding and decoding an order of product or service as claimed in claim 17, the instructions for making an order comprising
instructions for displaying the favorite list, when the order manner of making order from old orders saved in the favorite list is selected;
instructions for promoting to select an old order from the favorite list; and
instructions for ordering the old order selected.

19. The non-transitory computer-readable medium that stores instructions executable by one or more processors to perform an application for coding and decoding an order of product or service as claimed in claim 17, the instructions for making an order comprising
instructions for promoting to select items shown in the menu, when the order manner of making order from items shown in the menu is selected;
instructions for promoting to select quantities corresponding to items selected, wherein item selection and quantity selection are made via manual inputting with keys, via touching a touch screen, or via voice; and
instructions for repeating the item selections and quantity selections for additional users.

20. The non-transitory computer-readable medium that stores instructions executable by one or more processors to perform an application for coding and decoding an order of product or service as claimed in claim 17, comprising
the handheld device is a mobile phone or a tablet computer;
instructions for customizing the order;
instructions for ordering a sandwich and customizing to including various quantities of onion and cheese;
instructions for making the matrix bar code including a plurality of different orders corresponding to a plurality of individual customers; and
instructions for individually packing the plurality of different orders for the plurality of individual customers.
